(19) United States
(12) Patent Application Publication
(10) Pub. No.: US 2005/0050228 A1
(43) Pub. Date: Mar. 3, 2005

(54) Method and apparatus for the use of dynamic XML message formats with web services

(76) Inventors: Michael Perham, Austin, TX (US); Chaitanya Laxminarayan, Austin, TX (US); Matthew Sanchez, Round Rock, TX (US); Keith Yarbrough, Austin, TX (US)

Correspondence Address: Rick B. Yeager, 10805 Mellow Lane, Austin, TX, 78759, US

(21) Appl. No.: 10/881,585

(22) Filed: Jun. 30, 2004

Related U.S. Application Data
(60) Provisional application No. 60/498,837, filed on Aug. 29, 2003.

(51) Int. Cl. G06F 15/16

(52) U.S. Cl. 709/246

(57) ABSTRACT

A service proxy is used to automatically supply the message-format parameters required for incoming message communications to a web-service provider from client applications through a message-conversion system that the web-service provider previously sets up. For outgoing messages from the web service to client businesses, the service proxy automatically supplies the required message-format parameters according to service policies that client businesses set up previously through the web-service provider's web-site interface. The format of client application messages is predefined for a web service policy, and a configuration interface is established for context variables and message format variables. This service profile is recalled in order to apply the proper message format parameters for a web service request.

### CROSS-REFERENCE TO RELATED APPLICATIONS

This application claims the benefit of PPA Ser. No. 60/498,837, filed Aug. 29, 2003 by the present inventors.

### FIELD OF THE INVENTION

This innovation relates to web services, and, more particularly, to methods that supply the message-format parameters required for communications between a web-service provider and its client businesses' applications.

### BACKGROUND OF THE INVENTION

Web Services

The promise of the Internet is an open e-business platform where companies can do business spontaneously with anyone, anywhere, and anytime without requiring that companies abandon their existing software applications and infrastructures. Increasingly companies rely on the Internet to obtain loosely coupled web services deployed by web-service providers on application-based servers, which are computers on networks that mange the networks.

Web services are business-enterprise computer applications that can be utilized singly or collectively to accomplish a wide range of intended purposes, such as determining health-care patients' eligibility for benefits, submitting health-care claims, and providing stock quotes. Web services help companies dramatically cut costs, increase revenues, and improve competitive agility by combining existing, heterogeneous systems into cross-functional, multi-company applications. For example, web services designed for insurance companies help them rapidly automate their business processes, eliminating paper and manual touches and saving them tens of millions of dollars annually. To supply such valuable and widely needed services, Web services providers may offer multiple web services to client businesses.

Because web services can operate independently of a particular computer language, platform, or location, a client business and a web service may each use different computer languages, platforms, and locations in widely distributed systems over one or more networks.

Open web-service standards have been developed for compatibility among web-service applications. A standard called SOAP (Simple Object Access Protocol) has been developed to define the format of messages exchanged among applications. The content of messages, such as a request for an action to be performed by a web service, is currently described in WSDL (Web Services Description Language), which is an XML (Extensible Markup Language)-formatted language. Web services are cataloged in a web-based directory and infrastructure called UDDI (Universal Description, Discover and Integration), which is an Internet registry where businesses list themselves according to their services. Communications between a client business and a web service further rely on the use of a shared transport protocol, such as HTTP (Hypertext Transport Protocol), which enables communications over the Internet.

Typically a client business employs a client application to communicate from its web site over the Internet according to these standards, to obtain the web services offered by a web-service provider from its server-based web site. The web-service provider uses the same standards to reply to a client. Other known or not-yet-known web-service protocols and standards may be used for this communications.

Soap Envelopes

To communicate with a web service, a client application typically uses the Internet to send the web service a message containing a SOAP envelope. The SOAP envelope in turn contains context headers and a message body, where the headers indicate such parameters as the web service to be invoked, the identity of the sender, and the channel to be used for transmissions. The message body indicates the message being sent to the web service, for example a request to calculate the number of patient claims at a health insurance company, and is composed according to varying types of message-format parameters.

SOAP Message-Format Parameters

The following is an example of the message body of a SOAP message in a typical HIPAA (Health Insurance Portability and Accountability Act) format:

```
<soap:envelope>
  <soap:body>
          <SubmitClaim xmlns:ns=“http://example.com/proxy/types”>
              <Claim> MIID1DCCArwCAQAwDQYJ... </Claim>
          </SubmitClaim>
  </soap:body>
</soap:envelope>
```

In this example, “<SubmitClaim xmlns:ns=“http://example.com/proxy/types”>” is an XML element that represents the application data directed to the web service for processing. The expression “<Claim>MIID1DCCArwCAQAwDQYJ . . . </Claim>” represents further, detailed data directed to the web service.

However, a client application may be set up to provide SOAP message body parameters that are semantically similar to but syntactically different from those used by a particular web service. For example, a client application might try to accomplish the same functionality as in the previous example through a SOAP message with the following message body using NSF (National Science Foundation) format:

```
<soap:envelope>
  <soap:body>
        <UploadClaim xmlns:ns=“http://example.com/proxy/types”>
            <NSFFile> MIID1DCCArwCAQAwDQYJ... </NSFFile>
        </UploadClaim>
  </soap:body>
```

In this example, the message-body format uses the XML element
<UploadClaim xmlns:ns=“http://example.com/proxy/types”>
   instead of
<SubmitClaim xmlns:ns=“http://example.com/proxy/types”>
   And it uses the application data
<NSFFile>MIID1DCCArwCAQAwDQYJ . . . </NSFFile>
   instead of
<Claim>MIID1DCCArwCAQAwDQYJ . . . </Claim>

Such message-format differences can make communications between a client application and a web service impossible.

Prior Techniques for Message-Format Compatibility

To ensure message-format compatibility, a web-service provider typically sets up its web services to use specific SOAP message-format parameters and publishes the parameters for each web service it provides in a WSDL file. Client businesses' applications access a specific web service's WSDL file through a published URL address to automatically incorporate into their messages the message-format parameters required for that web service.

However, when a web-service provider changes its WSDL file for a web site to accommodate improvements in its offerings, it may have legacy client businesses with applications still configured for the old WSDL.

Another method of ensuring message-format compatibility is for the client business to manually program its applications on an ad hoc basis to contain the correct message-format parameters for a web service. Or a web-service provider can manually program a client business' applications for the client business. But manual programming is labor-intensive, requires special skills, and is therefore expensive.

US patent application number US2004/0068586 to Xie describes a web-service broker that provides to a limited extent for the automatic conversion of message formats between a web service and its client businesses' applications. But that application does not adequately explain how its methods provide for automatic conversion of message formats for outgoing, response messages from a web service to a client application. Nor do its methods provide for the further advantage of automatic conversion of outgoing messages from a web service according to a user-configured interface.

World Intellectual Property Organization patent application number WO 2004/010297 A1 to Butterworth describes a method of supplementing operations performed by a web service through an autonomous software agent to facilitate the examination of the content of messages, the modification of the content of messages, the rerouting of messages, and the analysis of the content of messages. But that method also does not address automatic conversion of message-format parameters in specific and sufficient detail. Nor does it provide the further advantage of automatic conversion of outgoing messages from a web service according to a user-configured interface.

Therefore there is a need for a method and apparatus that provides a more automatic method for supplying the required message-format parameters used for communications between a web-service provider and its client businesses.

### BRIEF SUMMARY OF THE INVENTION

These and other needs are addressed by the present invention. The following explanation describes the present invention by way of example and not by way of limitation.

It is an aspect of the present invention to provide a method for converting the message-format parameters required for communications between web services and client businesses that is automatic.

It is another aspect of the present invention to provide a method for converting the message-format parameters of messages from client applications to web services into the message-format parameters that are required by the web services.

It is another aspect of the present invention to provide a method for converting the message-format parameters of messages from web services to client applications into the message-format parameters required by the client applications.

It is another aspect of the present invention to provide a system that employs the methods of the present invention for supplying the message-format parameters required for communications between web services and client applications.

These and other aspects, features, and advantages are achieved according to the method and apparatus of the present invention. In accordance with the present invention, a service proxy is used to automatically supply the message-format parameters required for incoming message communications to a web-service provider from client applications through a message-conversion system that the web-service provider previously sets up. For outgoing messages from the web service to client businesses, the service proxy automatically supplies the required message-format parameters according to service policies that client businesses set up previously through the web-service provider's web-site interface.

### BRIEF DESCRIPTION OF THE DRAWINGS

The following embodiment of the present invention is described by way of example only, with reference to the accompanying drawings, in which:

FIG. 1 is a block diagram showing an operating environment in which embodiments of the present invention may be employed;

FIG. 2 is top-level flow chart that illustrates a process for a web-service provider to automatically supply the correct message-format parameters used for message communications between a web-service provider and its client businesses;

FIG. 3 is a flow diagram that illustrates a process for a web-service provider to set up a message-message-conversion system;

FIG. 4 is a block diagram that illustrates the SOAP information contained in a client application message;

FIG. 5 is a block diagram that illustrates a configuration interface that the web-service provider sets up so that a web-service client can configure message-context information and message-format parameters;

FIG. 6 is a block diagram of a metadata storage;

FIG. 7 is a block diagram that illustrates the components used by a service proxy;

FIG. 8 is a block diagram that illustrates the context information used by a service proxy to convert message-format parameters;

FIG. 9 is a flow diagram that illustrates a process of storing client-specified message-format configurations;

FIG. 10 is a flow diagram that illustrates a process used to apply correct message-format parameters to messages;

FIG. 11 is a flow diagram that illustrates a process a service proxy uses to apply correct message-format parameters to incoming messages from client applications to a web service;

FIG. 12 is a flow diagram that illustrates a process a service proxy uses to apply correct communication parameters to outgoing messages from a web service to a client application;

FIG. 13 is a block diagram that illustrates a typical computer system, representing a web service provider server on which embodiments of the present invention can be implemented;

FIG. 14 is a block diagram showing an alternate operating environment in which embodiments of the present invention may be employed; and

FIG. 15 is a block diagram showing a second alternate operating environment in which embodiments of the present invention may be employed.

### DETAILED DESCRIPTION

The following description explains a method and apparatus that automatically converts message-format parameters used for communications between web services and client applications. The details of this explanation are offered to illustrate the present invention clearly. However, it will be apparent to those skilled in the art that the concepts of the present invention are not limited to these specific details. Commonly known elements are also shown in block diagrams for clarity, as examples and not as limitations of the present invention.

Operating Environment

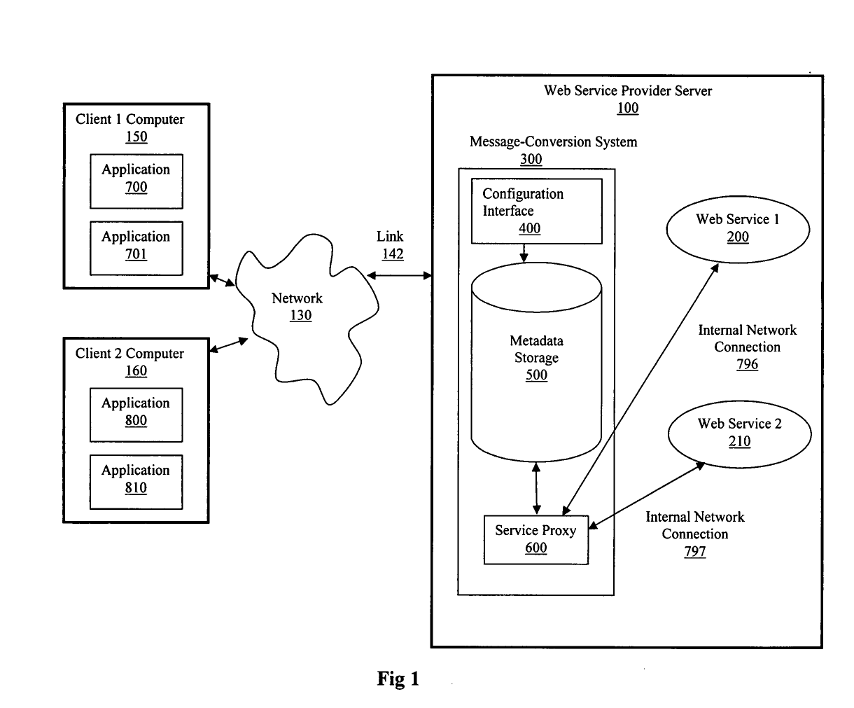

An embodiment of the operating environment of the present invention is shown in FIG. 1. A web-service provider employs a server 100 to deliver one of more web services 200 and 210, which may or may not be related and which may supply independent or combined processing, to client businesses. The server 100 can be a personal computer or a larger computerized system or combination of systems.

One or more client business, which may be related or of different types, employ one or more computers 150 and 160 to communicate over a communications network 130 and a wired or wireless link 142 with the web-service provider server 100. The client business computers 150 and 160 can be personal computers or computerized systems or combinations of systems comprising servers, for example.

The network 130 can be the Internet, a private LAN (Local Area Network), a wireless network, a TCP/IP (Transmission Control Protocol/Internet Protocol) network, or other communications system, and can comprise multiple elements such as gateways, routers, and switches.

To supply the correct message-format parameters, web-service provider server 100 employs a message-conversion system 300, comprising a configuration interface 400, metadata storage 500, and a service proxy 600. The service proxy 600 communicates with one or more web services 200 and 210 through one or more internal network connections 796 and 797. In an embodiment, the elements of message-conversion system 300 comprise a discrete system, but they can be distributed more loosely throughout the operating environment, as necessary and advantageous.

Through the operating environment shown in FIG. 1, a client application 700 can communicate with a web service 200 offered by a web-service provider server 100. A client application is a software program with one or more sequences of instructions in a SOAP message body that can request information from general or specific web services and with further SOAP instructions in context headers that can supply context information about the application.

Process of Converting Message-Format Parameters—Overview

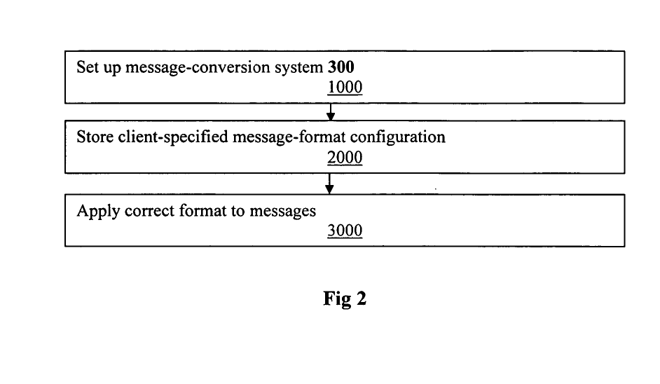

FIG. 2 is top-level flow chart that illustrates a process for a web-service provider to automatically supply the correct message-format parameters used for message communications between a web-service provider and its client businesses in this embodiment. It will be useful to explain the steps in this process briefly from a high level and then to expand elements of this explanation in detail.

Step 1000. Set up message-conversion system 300.

In this embodiment, the web-service provider creates a message-conversion system 300, shown in FIG. 1, comprising a configuration interface 400, metadata storage 500, and a service proxy 600.

Step 2000 in FIG. 2. Store client-specified message-format configuration.

In this embodiment, a client business accesses the configuration interface 400, shown in FIG. 1, on the web-service provider's web site and indicates the message-format parameters the client business wants to apply to outgoing messages from one or more web services 200 and 210 to a client application 700.

Step 3000 in FIG. 2. Apply correct format to messages.

In this embodiment, the message-conversion system 300, shown in FIG. 1, uses the client configuration and its internal instructions to apply correct message-format parameters to messages between client applications 700 and 701 and the web-service provider's web services 200 and 210.

Setting Up a Message-Conversion System

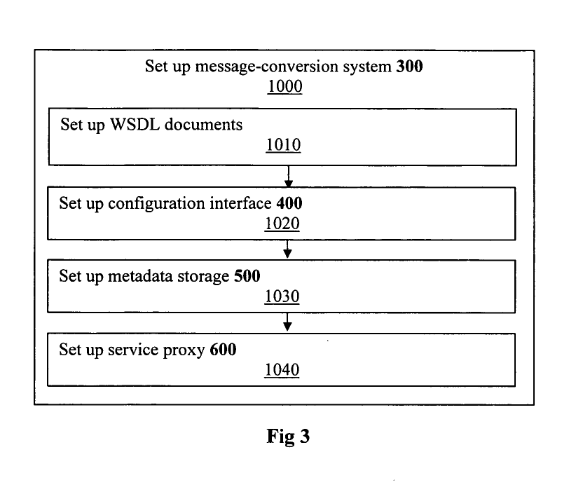

FIG. 3 illustrates a process in this embodiment for a web-service provider to set up a message-conversion system 300, shown in FIG. 1, at Step 1000, shown in FIG. 2.

Step 1010 in FIG. 3. Set up WSDL documents.

In this embodiment, the web-service provider creates a set of WSDL documents that can be used to generate SOAP client applications and client-application messages. The web-service provider publishes these documents so that client applications can access them and automatically incorporate their communications parameters into their messages. And the web-service provider uses the headers provided in SOAP messages to communicate context information to a message-conversion system 300 shown in FIG. 1.

Context Information

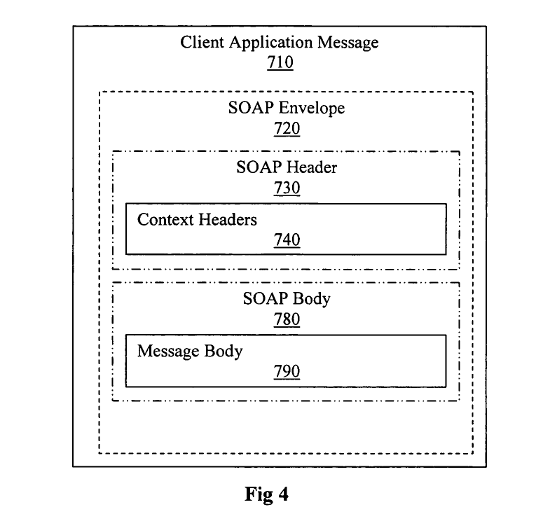

FIG. 4 is a block diagram that illustrates information that may be contained in a client application message 710. The message comprises a SOAP envelope 720, which in turn comprises a SOAP header 730 for context information and a SOAP body 780 for the web-service request.

The context headers 740 in the SOAP header 730 determine parameters such as the identity of the client, the transport channel to be used, and the specific web service to be contacted. For example, FIG. 1 shows a web service provider offering two web services 200 and 210. A client application message 710, shown in FIG. 4, from client computer 1 150, shown in FIG. 1, could contain a web-service header that specifies that the message be sent to the URL for web service 1 200. A second message from client computer 1 150 could contain a web-service header that specifies that the message be sent to the URL for web service 2 210.

The message body 790 in the SOAP body 780, shown in FIG. 4, indicates the specific action requested from a web service, such as a request for patient claims information or for a stock quote.

In an embodiment, the present invention uses the SOAP information in client messages to automatically supply message-format parameters to messages from and to client applications.

In another embodiment, the present invention uses context information supplied through HTTP POST or GET parameters, instead of or in addition to SOAP information.

Example of Context Information in Client Application Message

For example, a client business might create headers with the following context information in a SOAP envelope 720 that would accompany one of its application messages 710 to a web service 200, shown in FIG. 1:
Web Service Header: Patient claims Service
User Header: Insurance Company A
Message Body 790: Report on new patient claims for Insurance Company A.
   Setting Up a Configuration Interface

In this embodiment, the next step in creating a message-conversion system 300 in FIG. 1 at Step 1000, shown in FIG. 2, is the following:

Step 1020 in FIG. 3. Set up configuration interface.

Web-site interfaces are computer-programmed modules that allow end-users to select variables and parameters from easy-to-use visual displays or to type in this input, save the information through selecting a save option, and have their selections automatically applied by computer subsequently, without those users having to program the information manually.

In an embodiment, the web-service provider creates a configuration interface 400, shown in FIG. 1, which client businesses can access over the Internet by entering the URL for the web-service provider's server 100. Client businesses can then employ the configuration interface 400 to set up message-format parameters to be applied automatically to outgoing messages from a web service 200 to a client application 700.

In an alternate embodiment, a web-service provider can set up and store these parameters for client businesses.

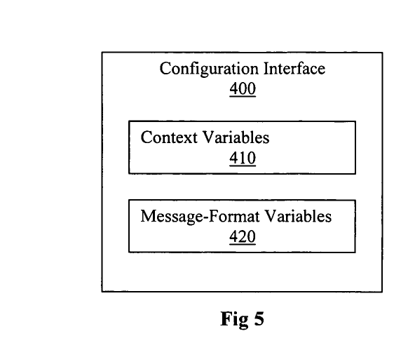

FIG. 5 shows variables useful for the configuration interface 400, shown in FIG. 1, of an embodiment, comprising context variables 410 and message-format variables 420. The context variables 410 may indicate elements such as the web service to be used and the client business.

For the message-format variables, the web-service provider sets up conversion data that a conversion algorithm uses to convert XML or binary data in that XML. For example, in one embodiment the web-service provider gives that conversion data a simple name, which is shown to the user in the configuration interface 400 so that the user can select it when necessary.

Setting Up a Metadata Storage

In this embodiment, the next step in creating a message-conversion system 300 in FIG. 1 at Step 1000, shown in FIG. 2, is the following:

Step 1030 in FIG. 3. Set up metadata storage.

Metadata storage 500, shown in FIG. 1, may be non-volatile data storage used to store the parameters for communications variables supplied by the client business through the configuration interface 400 and information created by the web-service provider for applying and administering message-format parameters. In addition, metadata storage 500 provides access to these user configurations and to web-service provider information to the service proxy 600.

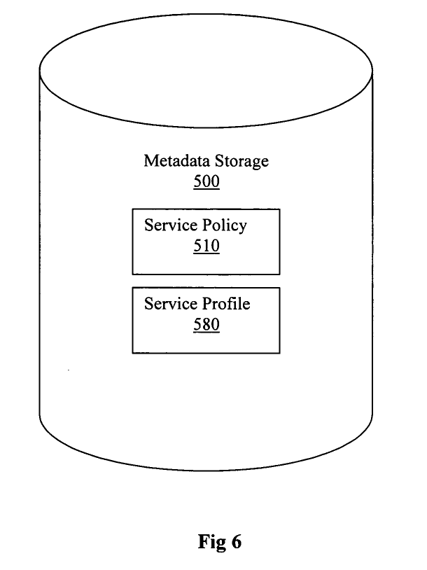

FIG. 6 shows that metadata storage 500 may store user-configured parameters as service policies 510 and web-service-provider-configured information as service profiles 580.

Service Policies

A client business with multiple users and client applications might have multiple corresponding service policies that would be stored in metadata storage 500. Different client businesses would also potentially have multiple different service policies for their employees and client applications that would be stored in metadata storage 500.

Example of a Service Policy

A service policy configured by a client business on configuration interface 400, shown in FIG. 1, for a client application 700 that only receives messages in format Y might contain the following information:
For a client application with the following SOAP header context information:
   Web Service Header: Patient claims Service
   User Header: Company 1: Application 1 apply to outgoing messages
   Message-Format Parameter: Format Y
      Service Profile

A service profile 580 in FIG. 6 may represent data a web-service provider creates to specify web-service information, such as the message-format parameters that a specific web service can use. The metadata storage may store multiple service profiles 580 for multiple web services.

Setting Up a Service Proxy

In this embodiment, the final step in creating a message-conversion system 300, shown in FIG. 1, at Step 1000, shown in FIG. 2, is the following:

Step 1040 in FIG. 3. Set up service proxy.

A service proxy 600, shown in FIG. 1, may be a computer software program, comprising one or more engines. For the message-conversion system 300, the web-service provider may create a service proxy 600 that manages the conversion of formats for messages between one or more client applications 700, 701, 800, and 810 and one or more web services 200 and 210 and relays each message to the appropriate web service for execution. The service proxy 600 may be programmed to work specifically with specific client applications 700, 701, 800, and 810 or to work generally with any invoking client application.

In an embodiment, a client application message 710, shown in FIG. 4, can be sent to a URL for a web service 200, shown in FIG. 1. But the service proxy 600 is set up by the web-service provider to receive all client application messages first and afterwards to employ the URL information to send them on to the correct web service 200.

In another embodiment, a client application message 710, shown in FIG. 4, contains context information in its SOAP header 730 that directs the message to the correct web service 200, shown in FIG. 1. But again the service proxy 600 is set up by the web-service provider to receive all client application messages first and afterwards to employ a message's SOAP context information to send that message 710, shown in FIG. 4, on to the correct web service 200, shown in FIG. 1.

Elements Employed by Service Proxy

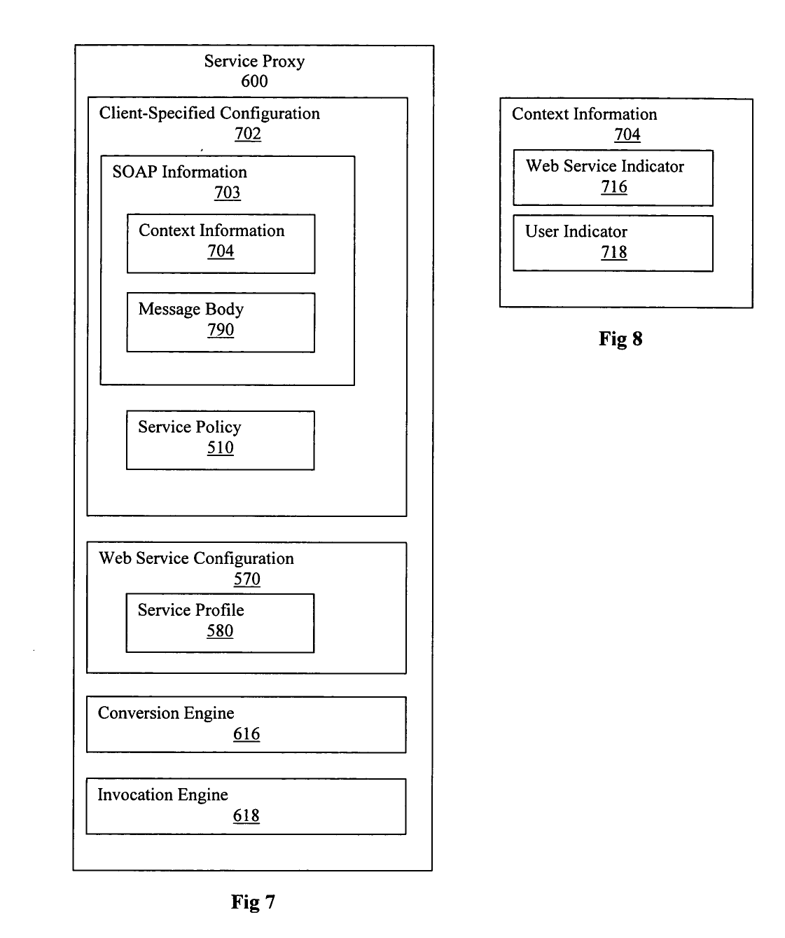

FIG. 7 is a block diagram that illustrates the elements that a service proxy 600 employs, which comprise
client-specified configuration information 702;
web-service-specified configuration information 570;
a conversion engine 616; and
an invocation engine 618.
   Client-Specified Configuration Information

The client-specified configuration information 702 that service proxy 600 may employ to convert message-formats comprises SOAP information 703 and one or more service policies 510.

SOAP Information

The SOAP information 703 is contained in the SOAP envelope 720, shown in FIG. 4., of a client application message 710, and comprises context information 704, shown in FIG. 7, and a message body 790.

Message Body Information

The message body information 790 shown in FIG. 7 is also contained in the SOAP envelope 720, shown in FIG. 4, of a client application message 710. The message body information 790, shown in FIG. 7, contains instructions, in the message-format employed by the client application 700, shown in FIG. 1, to the web service 200 being invoked.

Service Policy

The service policy 510, shown in FIG. 7, represents message-format data that a client business has set up through a web-service provider's configuration interface 400 in FIG. 1, for use with outgoing messages from a web service 200 in FIG. 1 to a client application 700.

Web-Service Configuration Information

The web-service configuration information 570, shown in FIG. 7, comprises the service profile 580 for the specific web service 200, shown in FIG. 1, being invoked, and indicates the message-format parameters required by the web service 200. The service profile 580, shown in FIG. 7, is stored in metadata storage 500 in FIG. 6. Many service profiles 580 for different web services may be stored in metadata storage 500.

The service proxy 600 in FIG. 7 uses the service profile 580 to determine the message-format parameters that the web service 200 in FIG. 1 requires.

Conversion Engine

The conversion engine 616 shown in FIG. 7 may be a software program representing a conversion algorithm that the service proxy 600 uses to convert messages between client applications and web services to the correct message-format parameters.

The web-service provider creates a conversion algorithm to convert known but incompatible message-format parameters into compatible ones. For example, in FIG. 1, suppose client application 700 is set up to send message-format X, but web service 1 200 is set up to receive message format A. Also, suppose client application 700 is set up to receive format Y, but web service 200 is set up to send format B, so that communication between the two is impossible.

To make communication possible in this case, conversion data would need to provide for the following conversions:
X to A
B to Y

When multiple client applications need to communicate with a web service, the conversion algorithm becomes more complex. For example, suppose client application 701 sends format M and receives format N. To ensure compatibility for client application 701 also, the conversion algorithm would need to provide for
X to A
B to Y
M to A
B to N

And when multiple web services and client applications are involved, the conversion algorithm would need to become more complex still. For example, suppose web service 200 receives format C and sends format D. The conversion algorithm would then need to accomplish the following conversions:
X to A
B to Y
M to A
B to N
X to C
D to Y
M to C
D to N
   Example of a Conversion Sequence

The following example shows the input format that might be required by a web service 200 to accomplish the operation “SubmitClaim.”

```
<definitions xmlns:typens=“http://example.com/healthservices/types”>
    <types>
        <element name=“SubmitClaim” type=“typens:claimType”>
        <complexType name=“claimType”>
            <element name=“Claim” type=“typens:hipaaFile”/>
        </complexType>
        <simpleType name=“hipaaFile” type=“xsd:base64Binary”/>
    </types>
    <message name=“SubmitClaimRequest”>
        <part name=“input” element=“typens:SubmitClaim”/>
    </message>
    <portType name=“ClaimInterface”>
        <operation name=“SubmitClaim”>
            <input name=“SubmitClaimRequest”
            message=“tns:SubmitClaimRequest”/>
        </operation>
    </portType>
    <binding name=“ClaimHttpSoapBinding”>
        <operation name=“SubmitClaim”>
            <soap:operation/>
            <input>
                <soap:body use=“literal”/>
            </input>
        </operation>
    </binding>
</definitions>
```

To convert a client application message 710, shown in FIG. 4, that uses the term “UploadClaim,” instead of “SubmitClaim,” to invoke the same operation, the conversion algorithm might add the text shown in boldface to the WSDL for the web service 200, shown in FIG. 1, replacing elements when necessary:

```
<definitions xmlns:typens=“http://example.com/healthservices/types”>
            xmlns:proxyns=“http://example.com/proxy/types”>
    <types>
        <element name=“SubmitClaim” type=“typens:claimType”>
        <complexType name=“claimType”>
            <element name=“Claim” type=“typens:hipaaFile”/>
        </complexType>
        <simpleType name=“hipaaFile” type=“xsd:base64Binary”/>
        <element name=“UploadClaim”
        type=“ proxyns:claimType”><!-added new
        message type -->
        <complexType name=“claimType”>
            <element name=“Claim” type=“ proxyns:nsfFile”/>
        </complexType>
        <simpleType name=“nsfFile” type=“xsd:base64Binary”/>
    </types>
    <message name=“SubmitClaimRequest”>
        <part name=“input” element=“proxyns:UploadClaim”/><!-after
        modified element type -->
    </message>
    <portType name=“ClaimInterface”>
    <operation name=“SubmitClaim”>
            <input name=“SubmitClaimRequest”
            message=“tns:SubmitClaimRequest”/>
        </operation>
    </portType>
    <binding name=“ClaimHttpSoapBinding”>
        <operation name=“SubmitClaim”>
            <soap:operation/>
            <input>
                <soap:body use=“literal”/>
            </input>
        </operation>
    </binding>
</definitions>
```

Invocation Engine

The invocation engine 618 shown in FIG. 7 may be a software program that the service proxy 600 employs to relay a correctly formatted client application message 710, shown in FIG. 4, to a web service 200, shown in FIG. 1, and activate the web service 200 to execute the request contained in that message 710, shown in FIG. 4. The service proxy 600, shown in FIG. 7, also uses the invocation engine 618 to send messages to client applications 700, shown in FIG. 1.

Receiving and Storing Configurations

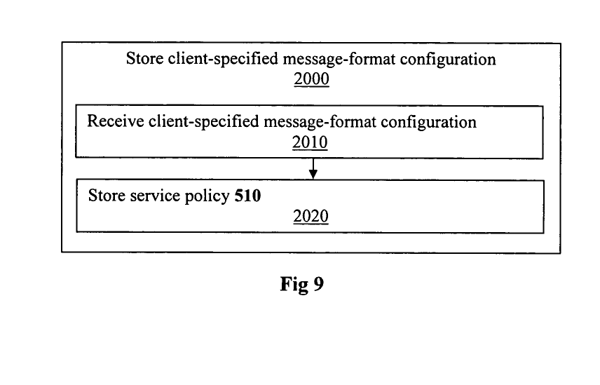

To return to FIG. 2, after setting up message-conversion system 300 in Step 1000, shown in FIG. 2, a web-service provider can use message-conversion system 300 to store client message-format configurations in Step 2000. Message-conversion system 300 accomplishes this by receiving client configurations in Step 2010 in FIG. 9 through the configuration interface 400 in FIG. 1.

Message-conversion system 300 then stores these client configurations in metadata storage 500, as service policies 510, shown in FIG. 6, as indicated in Step 2020 in FIG. 9.

Applying the Correct Format to Messages

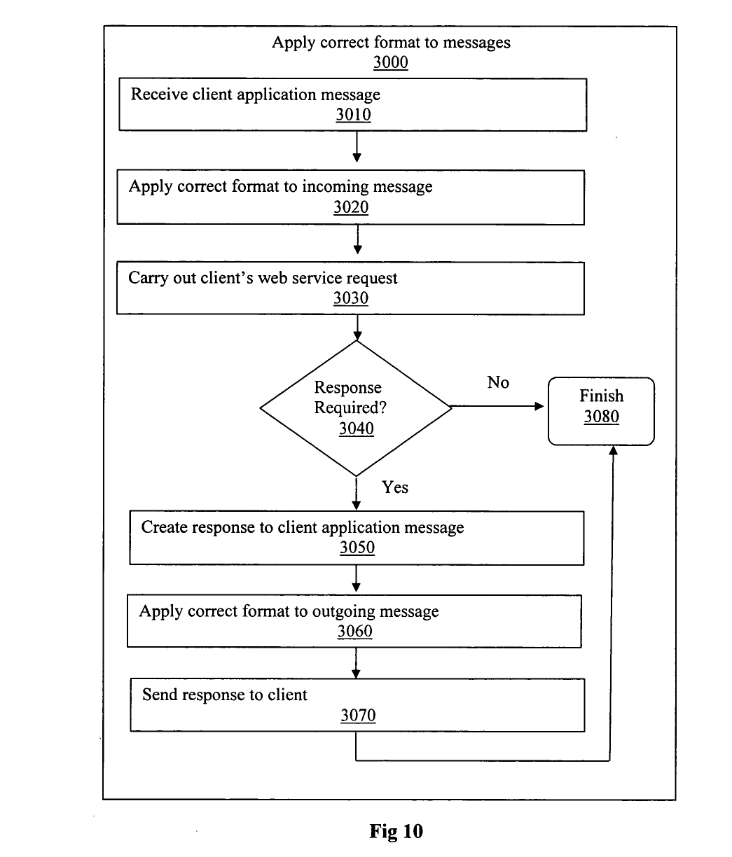

Returning again to FIG. 2, the final step, Step 3000, in the overall process of this embodiment, is to convert messages between client applications and web services to the correct formats. The details of Step 3000 are shown in FIG. 10.

Converting Incoming Messages

Step 3010 in FIG. 10. Receive client application message.

The service proxy 600 in FIG. 1 receives a message from a client application 700.

Step 3020 in FIG. 10. Apply correct format to incoming message.

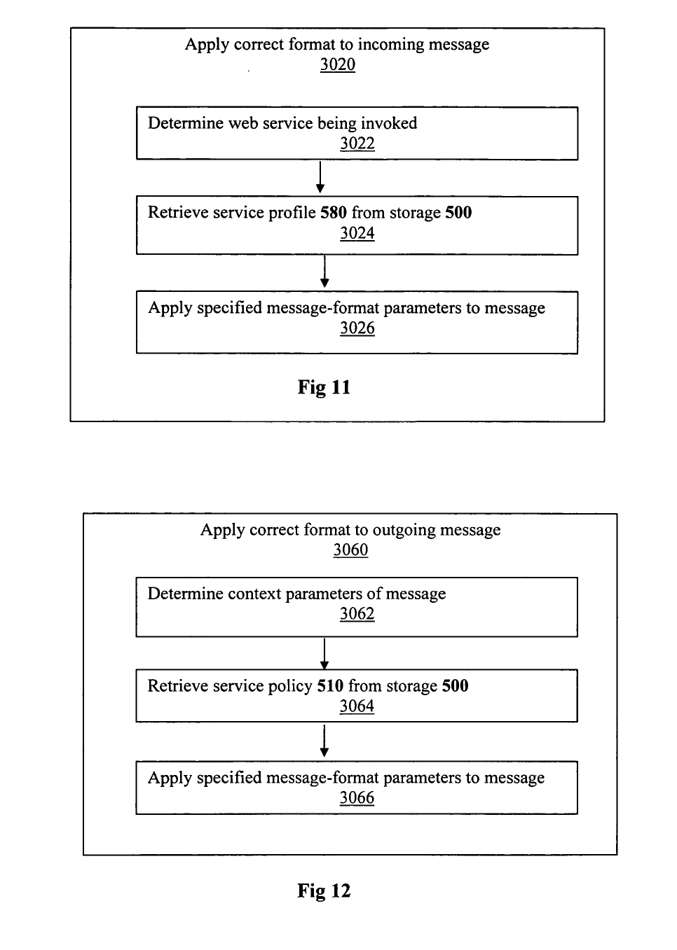

The service proxy 600 in FIG. 1 automatically converts the client application message 710, shown in FIG. 4, to the correct format, following the steps outlined below in FIG. 11.

Step 3022 in FIG. 11. Determine web service being invoked.

The service proxy 600 reads the context parameters in the client application message 710, shown in FIG. 4, located either in the URL destination address or the SOAP header 730, and determines the web service 200, shown in FIG. 1, that the client application 700, shown in FIG. 1, is invoking.

Step 3024 in FIG. 11. Retrieve service profile 580 from storage 500.

The service proxy 600, shown in FIG. 1, retrieves from metadata storage 500 the service profile 580, shown in FIG. 6, for the web service 200 being invoked.

Step 3026 in FIG. 11. Apply specified message-format parameters to message.

The service proxy 600, shown in FIG. 1 uses the conversion engine 616, shown in FIG. 7, to convert client application message 710, shown in FIG. 4, to the format specified in the service profile 580, shown in FIG. 6.

Step 3030 in FIG. 10. Carry out client's web service request.

The service proxy 600, shown in FIG. 1 sends the converted message to the specified web service 200 to execute the client's request. The web service 200 executes the request contained in the SOAP message body 790, shown in FIG. 4, of the client application message 710.

Converting Outgoing Messages

In some cases a client application may require a response. For example, a client application message might be a submission of a patient's insurance claim to a web service that records patient claims, evaluates them, and pays them. The client application message may also request a response from the web service indicating that the web service received the claim and providing a tracking tag that can be used to determine the status of the claim.

Step 3040 in FIG. 10. Response Required?

If the answer is no, the process concludes with Finish 3080. The web service 200, shown in FIG. 1, has completed the request contained in the SOAP message body 790, shown in FIG. 4, of the client application message 710.

If the answer is yes, the process continues to Step 3050 in FIG. 10.

Step 3050 in FIG. 10. Create response to client application message.

The web service 200, shown in FIG. 1, creates an appropriate response to the client application message 710, shown in FIG. 4, and sends the response to the service proxy 600, shown in FIG. 1.

Step 3060 in FIG. 10. Apply correct format to outgoing message.

The service proxy 600 automatically applies the correct format to the outgoing message, following the steps outlined below in FIG. 12.

Step 3062 in FIG. 12. Determine context parameters of message.

After receiving the message from the web service 200, shown in FIG. 1, to the client application 700, the service proxy 600 employs the context parameters of the outgoing message. These context parameters are still known to the service proxy 600 from the corresponding incoming client application message 710, shown in FIG. 4.

Step 3064 in FIG. 12. Retrieve service policy 510 from storage 500.

Using the context parameters, the service proxy 600, shown in FIG. 1, retrieves from metadata storage 500, shown in FIG. 6, the correct service policy 510 for the message.

Step 3066 in FIG. 12. Apply specified message-format parameters to message.

The service proxy 600, shown in FIG. 1, applies the message-format parameters specified in the service policy 510, shown in FIG. 6, to the outgoing message through conversion engine 616, shown in FIG. 7.

Step 3070 in FIG. 10. Send message to client.

Returning to FIG. 10, the service proxy 600 in FIG. 1 sends the converted message to the client application 700.

Step 3080. Finish.

After the service proxy 600 in FIG. 1 sends the correctly formatted message to the client application 700, the message-conversion process finishes.

Computer System Overview

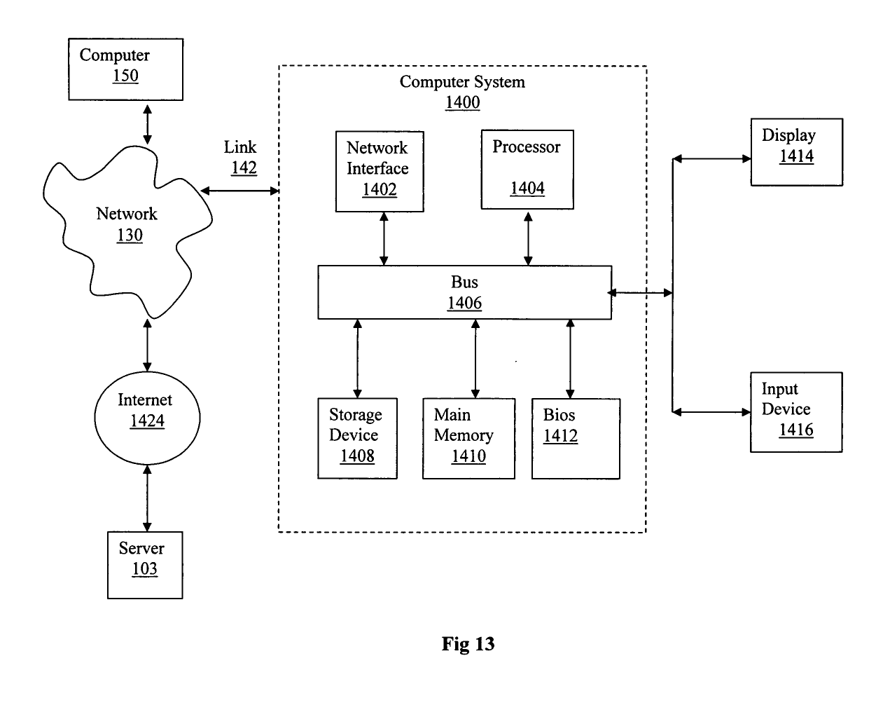

FIG. 13 is a block diagram that illustrates a typical computer system 1400, well known to those skilled in the art, representing a web service provider server 100 on which embodiments of the present invention can be implemented. This computer system 1400 comprises a network interface 1402 that provides two-way communications through a wired or wireless link 142 to a wired or wireless communications network 130 that uses any applicable communications technology. For example, the network 130 can comprise a public telephone network, a wireless network, a local area network (LAN), and any known or not-yet-know applicable communications technologies, using correspondingly applicable links. The network 130 in turn provides communications with one or more host computers 150 and, through the Internet 1424, with one or more servers 103.

The network interface 1402 is attached to a bus 1406 or other means of communicating information. Also attached to the bus 1406 are the following:
a processor 1404 for processing information;
a storage device 1408, such as an optical disc, a magneto-optical disc, or a magnet disc, for storing information and instructions;
main memory 1410, which is a dynamic storage device such as a random access memory (RAM) that stores information and instructions to be carried out by processor 1404;
a bios 1412 or another form of static memory such as read only memory (ROM), for storing static information and instructions to be carried out by processor 1404;
a display 1414, such as a liquid crystal display (LDC) or cathode ray tube (CRT) for displaying information to user of the computer system 1400; and
an input device 1416, with numeric and alphanumeric keys for communicating information and commands to processor 1404. In another embodiment a mouse or other input devices can also be used.

The computer system 1400 is used to implement the methods of the present invention in one embodiment. However, embodiments of the present invention are not limited to specific software and hardware configurations. Computer system 1400 can receive data comprising client application messages from computer 150 and server 103 used by client business, through a network 130 such as the Internet, an appropriate links 142, such as wired or wireless ones, and its network interface 1402. It can of course transmit data back to client business application over the same routes.

Computer system 1400 carries out the methods of the present invention when its processor 1404 processes instructions contained in its main memory 1410. Another computer-readable medium, such as its storage device 1408, may read these instructions into main memory 1410 and may do so after receiving these instructions through network interface 1402. Processor 1404 further processes data according to instructions contained in its storage device 1408. Data is relayed to appropriate elements in computer system 1400 through its bus 1406. Instructions for computer system 1400 can also be given through its input device 1416 and display 1414.

“Computer-readable medium” refers to any medium that provides instructions to processor 1404, comprising volatile, non-volatile, and transmission media. Volatile media comprise dynamic memory, such as main memory 1410. Non-volatile media comprise magnetic, magneto-optical, and optical discs, such as storage device 1408. Transmission media comprise a wide range of wired and unwired transmission technology, comprising cables, wires, modems, fiber optics, acoustic waves, such as radio waves, for example, and light waves, such as infrared, for example. Typical examples of widely used computer-readable media are floppy discs, hard discs, magnetic tape, CD-ROMs, punch cards, RAM, EPROMs, FLASH-EPOMs, memory cards, chips, and cartridges, modem transmissions over telephone lines, and infrared waves. Multiple computer-readable may be used, known and not yet known, can be used, individually and in combinations, in different embodiments of the present invention.

Alternate Embodiments

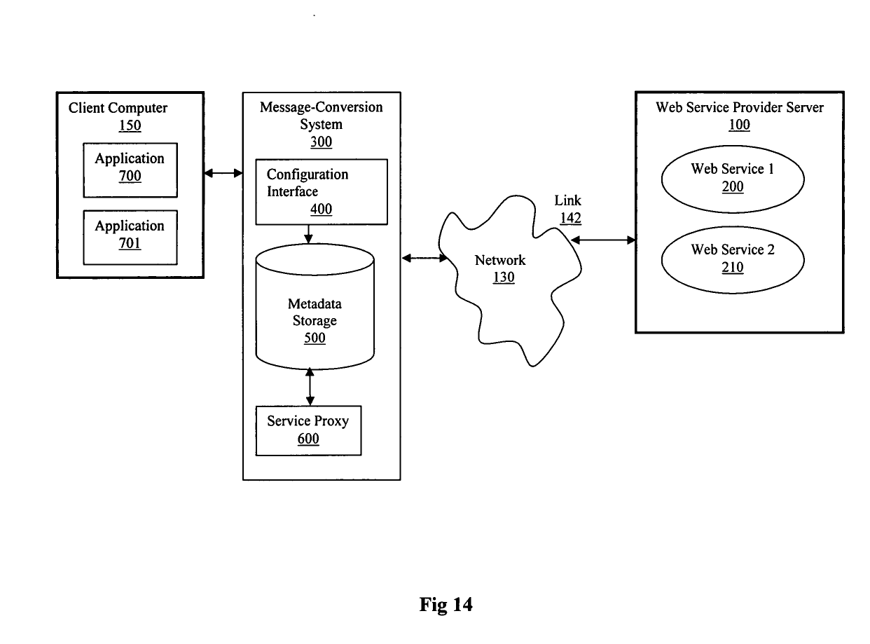

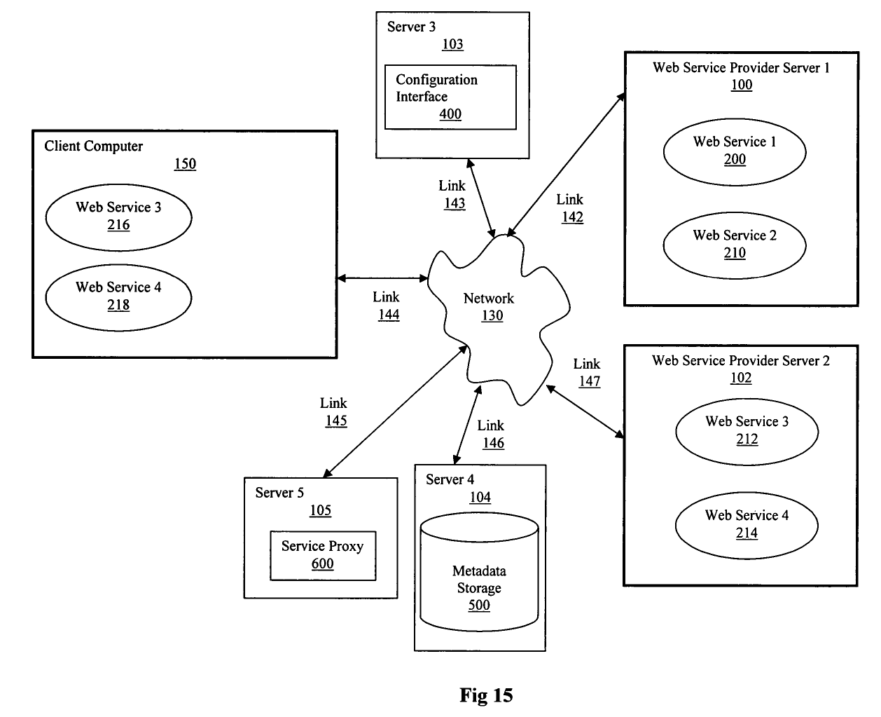

The previous extended description has explained some of the alternate embodiments of the present invention. It will be apparent to those skilled in the art that many other alternate embodiments of the present invention are possible without departing from its broader spirit and scope. For example, FIG. 14 is a block diagram showing an alternate operating environment in which embodiments of the present invention may be employed. In this alternate operating environment, the message-conversion system 300 can be attached to the client computer 150, as an internal element or a plug-in module, instead of to a web-service provider server 100 as shown in FIG. 1.

Other embodiments of the present invention are possible where the message-conversion elements are widely and diversely dispersed among systems. For example, FIG. 15 is a block diagram showing a second alternate operating environment in which embodiments of the present invention may be employed. In this example, the configuration interface 400 can be located on an independent server 103, the service proxy 600 on another server 105, and the metadata storage 500 on yet another server 104. Web services 200 and 210 can be on another server 100, more web services 212 and 214 on another server 102, and additional web services 216 and 218 on a client computer 150 can all be interrelated through such a loose system. Communications among these separated elements take place through a network 130 and multiple links: 142, 143, 144, 145, 146, and 147.

It will also be apparent to those skilled in the art that different embodiments of the present invention may employ a wide range of possible hardware and of software techniques. For example the communication between a web service provider and client business computers could take place through any number of links including wired, wireless, infrared, or radio ones and through other communication networks beside those cited, including any not yet in existence.

Also, the term computer as used here is used in its broadest sense to include personal computers, laptops, telephones with computer capabilities, personal data assistants (PDAs) and servers, and it should be recognized that it could include multiple servers, with storage and software functions divided among the servers. A wide array of operating systems, compatible e-mail services, web browsers and other communications systems can be used to transmit messages among client applications and web services.

Furthermore, in the previous description the order of processes, their numbered sequences, and their labels are presented for clarity of illustration and not as limitations on the present invention.

1. An automatic method of supplying message-format parameters used for communications between a web service and a source, the method comprising the computer-implemented steps of:
predefining a message conversion system for client application messages between the web service and the source, such that the message conversion system comprises a configuration interface for the format of the client application messages;
converting, with the message conversion system, a client application incoming message for a web service request to the format required by the web service;
forwarding the client's web service request to the web service;
accepting an outgoing message response from the web service; and
converting, with the message conversion system, the outgoing message response to the format required by the source.

2. The method of claim 1 wherein predefining a message conversion system 300 further comprises
setting up a metadata storage, the metadata storage comprising
at least one service policy, and
a web service profile, such that the web service profile may be used to provide specific web-service information,

3. The method of claim 1 wherein predefining a message conversion system further comprises
predefining the format of a client application message between the web service and the source;
predefining a configuration interface for context variables and message-format variables for the client application message;
storing at least one service policy associated with the source, and a service profile associated with the web-service; and
setting up a service proxy.

4. The method of claim 3 wherein predefining the format of a client application message between the source and the web service further comprises
creating WSDL documents which specify the format of a plurality of client application messages between the source and the web service.

5. The method of claim 5 wherein the client application message further comprises
a SOAP envelope comprising
a plurality of context headers, and
a message body.

6. The method of claim 3 wherein predefining a configuration interface for context variables and message-format variables for the client application message further comprises
setting up a configuration interface comprising
a plurality of context variables, and
a plurality of interface variables.

7. The method of claim 3 wherein storing a service policy associated with the source, and a service profile associated with the web-service further comprises
storing the service policy and the service profile in a metadata storage.

8. The method of claim 3 wherein the service proxy further comprises
a client-specified message format configuration comprising
the service policy, and
a web service configuration comprising the service profile;
a conversion engine; and
an invocation engine.

9. The method of claim 1 wherein converting, with the message conversion system, a client application incoming message for a web service request to the format required by the web service further comprises
converting, with the message conversion system, the client application incoming
message for a web service request to the format required by the web service by
determining the web service to be invoked,
retrieving, from storage, the service profile for the web service to be involed, and
applying specified message format parameters to the client application incoming message.

10. The method of claim 9 wherein converting, with the message conversion system, the client application incoming message for a web service request to the format required by the web service further comprises
receiving a SOAP envelope comprising
a SOAP header comprising a plurality of context headers, and
a SOAP body comprising a message body.

11. The method of claim 10 further comprising
applying the correct format to the incoming message by
determining the web service to be invoked,
retrieving, from storage, the service profile for the web service to be invoked,
applying specified message format parameters to the client application incoming message.

12. The method of claim 1 wherein converting, with the message conversion system, the outgoing message response to the format required by the source further comprises
converting, with the message conversion system, the outgoing message response to the format required by the source by
determining the context parameters of the outgoing message response,
retrieving, from storage, the service policy associated with the source, and
applying specified message format parameters to the outgoing message response.

13. The method of claim 1 wherein converting, with the message conversion system, the outgoing message response to the format required by the source further comprises
sending a response to the source.

14. An automatic method of supplying message-format parameters used for communications between a web service and a source, the method comprising the computer-implemented steps of:
setting up a message conversion system by
predefining the format of a client application message between the web service and the source,
predefining a configuration interface for context variables and message-format variables for the client application message,
storing a service policy associated with the source, and a service profile associated with the web-service, and
setting up a service proxy comprising
a client-specified message format configuration comprising the service policy,
a web service configuration comprising a service profile,
a conversion engine, and
an invocation engine; and
converting, with the message conversion system, the client application incoming message for a web service request to the format required by the web service;
forwarding the client's web service request to the web service;
accepting an outgoing message response from the web service; and
converting, with the message conversion system, the outgoing message response to the format required by the source.

15. An automatic method of supplying message-format parameters used for communications between a web service and a source, the method comprising the computer-implemented steps of:
setting up a message conversion system by
predefining the format of a client application message between the web service and the source,
predefining a configuration interface for context variables and message-format variables for the client application message,
storing a service policy associated with the source, and a service profile associated with the web-service, and
setting up a service proxy comprising
a client-specified message format configuration comprising the service policy,
a web service configuration comprising a service profile,
a conversion engine, and
an invocation engine; and
storing client-specified message format configurations and service policies;
converting, with the message conversion system, the client application incoming message for a web service request to the format required by the web service by
determining the web service to be invoked,
retrieving, from storage, the service profile for the web service to be invoked, and
applying specified message format parameters to the client application incoming message;
forwarding the client's web service request to the web service;
accepting an outgoing message response from the web service; and
converting, with the message conversion system, the outgoing message response to the format required by the source by
determining the context parameters of the outgoing message response,
retrieving, from storage, the service policy associated with the source, and
applying specified message format parameters to the outgoing message response.

16. An automatic method of supplying message-format parameters used for communications between a web service and a source, the method comprising the computer-implemented steps of:
setting up a message conversion system by
predefining the formats of a plurality of client application messages, the messages comprising
a SOAP envelope comprising
a plurality of context headers, and
a message body,
setting up a configuration interface comprising
a plurality of context variables, and
a plurality of interface variables,
setting up a service proxy, the service proxy comprising
at least one client-specified message format configuration comprising context information,
at least one service policy,
a web service configuration comprising
a web service profile,
at least one conversion engine, and
at least one invocation engine;
storing client-specified message format configurations by
receiving a client-specified message format configuration, and
storing at least one service policy; and
applying the correct format to an incoming message by
receiving the client application incoming message comprising context information,
applying the correct format to the incoming message by
determining the web service to be invoked,
retrieving, from storage, the service profile for the web service to be invoked,
applying specified message format parameters to the client application incoming message,
forwarding the client's web service request to the web service;
accepting an outgoing message response from the web service; and
applying correct format to the outgoing message by
determining context parameters of the outgoing message,
retrieving, from storage, the service policy associated with the source, and
applying specified message format parameters to the outgoing message response, and
sending response to the source.

17. The method of claim 16 wherein predefining the formats of a plurality of a plurality of client application messages further comprises
setting up WSDL documents to define the formats.

18. The method of claim 16 wherein client-specified message format configuration further comprises
context information comprising
a web service indicator,
a user indicator, and
a message body.

19. The method of claim 16 wherein client-specified message format configuration further comprises
context information selected from the group consisting of SOAP headers, http POST parameters, and http query parameters.

20. The method of claim 16 wherein setting up a message conversion system further comprises
setting up a metadata storage, the metadata storage comprising
at least one service policy, and
a web service profile, such that the web service profile may be used to provide specific web-service information.

21. A system for automatically formatting an incoming web service request from a source, executing the request at the web service, and automatically formatting an outgoing message from the web service, the system comprising
at least one web service;
at least one source computer;
a message conversion system, such that the message conversion system is predefined
to format the incoming web service request, and
to format the outgoing message from the web service, and such that the message conversion system
dynamically converts the incoming web service request to a format required by the web service, and
dynamically converts the outgoing message from the web service to a format required by the source; and
network communication between the web service, the message conversion system, and the source computer.

22. The system of claim 21 wherein
the message conversion system is provided on the web service server.

23. The system of claim 21 wherein
the message conversion system is provided on a first server; and
the web service is provided on a second server.
